(19) United States
(12) Patent Application Publication
(10) Pub. No.: US 2016/0214052 A1
(43) Pub. Date: Jul. 28, 2016

(54) Filter Element Having a Plurality of Superposed Single Sheets

(71) Applicant: Mann+Hummel GMBH, Ludwigsburg (DE)

(72) Inventors: Nikolaus Moser, Ditzingen (DE); Markus Kolczyk, Mundelsheim (DE); Michael Heim, Korntal-Muenchingen (DE)

(21) Appl. No.: 15/004,835

(22) Filed: Jan. 22, 2016

(30) Foreign Application Priority Data
Jan. 23, 2015 (DE) 102015000660.6

(51) Int. Cl. B01D 46/52; F02M 35/024; B01D 46/00

(52) U.S. Cl. CPC B01D 46/521; B01D 46/0001; F02M 35/0245; F02M 35/02408

(57) ABSTRACT

A filter element, including: a plurality of superposed single sheets, each sheet including a corrugated layer; and a covering layer for forming parallel flow channels; wherein the plurality of superposed single sheets are connected to one another; wherein the plurality of single sheets are not flat and have at least one curvature and are connected in the curved state, so that the curved filter element formed from the single sheets is inherently stable and have an axis of curvature that extends parallel to the flow channels.

### TECHNICAL FIELD

The invention relates to a filter element with a plurality of superposed single sheets according to the preamble of claim 1.

### BACKGROUND OF THE INVENTION

It is known from EP 1 771 237 B1 to assemble a filter element from a plurality of superposed individual sheets, each consisting of a flat, smooth layer and a corrugated layer adhered thereto, wherein flow channels for the fluid to be purified are formed by the wave form of the corrugated layer. The flow channels are each open at one end and closed at the opposite end, so that the fluid, introduced axially via the open end, must pass through the wall of single sheets and the desired filtration is achieved.

### SUMMARY OF THE INVENTION

The object of the invention is to provide with simple measures a filter element with a plurality of superposed single sheets with corrugated layers, wherein the filter element can be easily adapted to different installation spaces.

This object is achieved according to the invention with the features of claim 1. The dependent claims specify expedient developments.

The filter element according to the invention is composed of a plurality of superposed single sheets, which each comprise a corrugated layer and a covering layer connected to the corrugated layer, between which are formed a plurality of adjacent flow channels extending parallel to one another. In contrast to the prior art, however, the single sheets are not flat and have at least one curvature, wherein the axis of the curvature extends parallel to the flow channels in the single sheets. For the formation of a filter element which is curved yet inherently stable, which retains its curved shape without the action of external forces, the non-planar single sheets are connected with one another in a curved state, whereby inherent stability is achieved, so that the single sheets with a corrugated layer and covering layer retain their curved form. The internal forces of the single sheets, which work to bring the single sheets back to a flat state, are absorbed between the different single sheets, which effects the desired stabilizing effect.

The various single sheets are advantageously stacked concentrically on one another in the region of the curvature, wherein the curved sections expediently have a common center point and the curvature decreases with the increasing radial section.

The curved filter element permits installation into receiving spaces with curvatures in a concave or convex manner or with projections, recesses, elevations, bends and the like, wherein the receiving spaces designed in this way can be filled better by means of curved filter elements than by a cuboidal filter element. Overall, an improved adaptation to the installation space and a higher utilization rate of the receiving space for the filter element thus result, so that, with an equal volume, a higher filtration performance can be achieved.

According to a preferred embodiment, the inherent stability of the filter element composed of a plurality of superposed single sheets is held in the inherently stable, curved shape by the connection between the single sheets. According to an alternative embodiment, it is provided that the inherently stable, curved shape is maintained by an additional stabilizing element, which is arranged on the single sheets and fixes these in the curved shape, for example a circumferential frame element or circumferential sealing element. Furthermore, it is possible to achieve the inherent stability via the direct connection between the single sheets, but to arrange an additional circumferential frame or sealing element on the filter element, which has an additional stabilizing effect.

The connection directly between the single sheets lying one atop the other preferably occurs through adhesion. The adhesive, for example a hot melt, is spread, for example, on the tops of the waves of the flow channels formed in the single sheets, on which the overlying single sheet is applied. In this way, the filter element may be formed with a plurality of superposed, mutually connected single sheets, which each have the same curvature.

It may be sufficient that each single sheet has exactly one curvature, so that the filter element formed from the single sheets also has exactly one curvature, and is designed, for example, as an arch. However, embodiments with more than one curvature are also possible, for example with two or three curvatures, which extend in particular in opposite directions, whereby the filter element receives an S-shape or wave shape. In this way, the filter element may be designed to be concave or convex, or, in the case of a plurality of curvatures, it may have both concave and convex sections. In the case of a plurality of curvatures, these may connect either directly to one another, or there may be a straight section between two curvatures.

According to an advantageous embodiment, identical or at least similar single sheets are used, which are equal with respect to their geometric parameters such as base area and waveform. The lateral end edges of the individual sheets, which in the connected state form the lateral surfaces of the filter element, advantageously each lie in one plane. The diametrically opposite lateral surfaces mad be aligned parallel to one another, or enclose an angle not equal to 180°. It may also be expedient to use differently sized single sheets for the different layers of the filter element. If necessary, the lateral end edges of the single sheets may undergo post-treatment to ensure that the end edges lie in one plane, wherein the planes of the opposite lateral surfaces of the filter element may be parallel or not parallel to one another.

According to a further advantageous embodiment, the lateral surfaces of the filter element are coated with an adhesive, for example with hot melt, in order to achieve a fluid-tight seal of the lateral surfaces. A lateral sealing may also be carried out with a foaming polyurethane material.

According to a further advantageous embodiment, each single sheet respectively comprises a level, flat-surfaced layer which is free from force in the initial state, and the corrugated layer with waveforms. The flow channels extend between the waveforms of the corrugated layer and the covering layer. In the adhesive connection of the superposed single sheets, the adhesive is preferably applied to the tops of the waves of the corrugated layer, and the single sheet lying thereover is placed with the covering layer facing the application of the adhesive.

The corrugated layer and/or the covering layer are preferably manufactured from a nonwoven material, a cellulose-based material or a mixture of these two materials.

Through the application of a sealant in the form of a bead, which runs parallel to the end face, the single sheets are sealed on one side with respect to one another. This results in alternatingly closed channels, i.e. channels open on the pure side and closed on the raw side, as well as channels closed on the pure side and open on the raw side. Ideally, the sealant is realized by a hot melt, which additionally causes a connection of the single sheets.

The filter element can be used for a gas filtration, in particular an air filtration. A filter apparatus which can be used for filtration comprises at least a filter housing and a filter element, designed in the manner described above, inserted in the filter housing. Such a filter apparatus forms, for example, an air filter for a motor vehicle for the filtration of combustion air to be supplied to an internal combustion engine, or for the filtration of air to be supplied to the vehicle interior.

In a method for producing a filter element which is constructed from a plurality of superposed single sheets, which are each designed with a corrugated layer and a covering layer connected with the corrugated layer for the formation of parallel flow channels, wherein the filter element has a curved shape and is inherently stable, in a first step at least one single sheet is initially placed onto a non-planar underlay, so that this single sheet follows the contour of the underlay. The placing of the single sheet onto a non-planar underlay is carried out in such a way that this single sheet is curved about an axis of curvature parallel to the flow channels. Then, at least a second single sheet with an adapted curvature is applied to the curved single sheet, wherein the flow channels in the different single sheets are aligned parallel to one another. The second, upper laying single sheet thus has the same curvature as the non-planar underlay. This process can be repeated several times, until the desired number of single sheets are stacked, wherein each single sheet is connected with the single sheet lying thereunder, in particular by means of adhesion.

### BRIEF DESCRIPTION OF THE DRAWINGS

Further advantages and expedient embodiments can be derived from the further claims, description of figures and drawings.

FIG. 1 shows a front view of a curved filter element with a plurality of superposed single sheets,

FIG. 2 shows a perspective view of a curved filter element with a circumferential sealing element on an end face,

FIG. 3 shows a further perspective view of a curved filter element with superposed single sheets, wherein the lateral surfaces of the filter element are smoothed,

FIG. 4 shows an arched curved filter element which, in the installed position, engages a projection in the receiving filter housing,

FIG. 5 shows a perspective view of a filter element with two opposing curvatures.

In the figures, identical components are provided with the same reference characters.

### DETAILED DESCRIPTION OF THE INVENTION

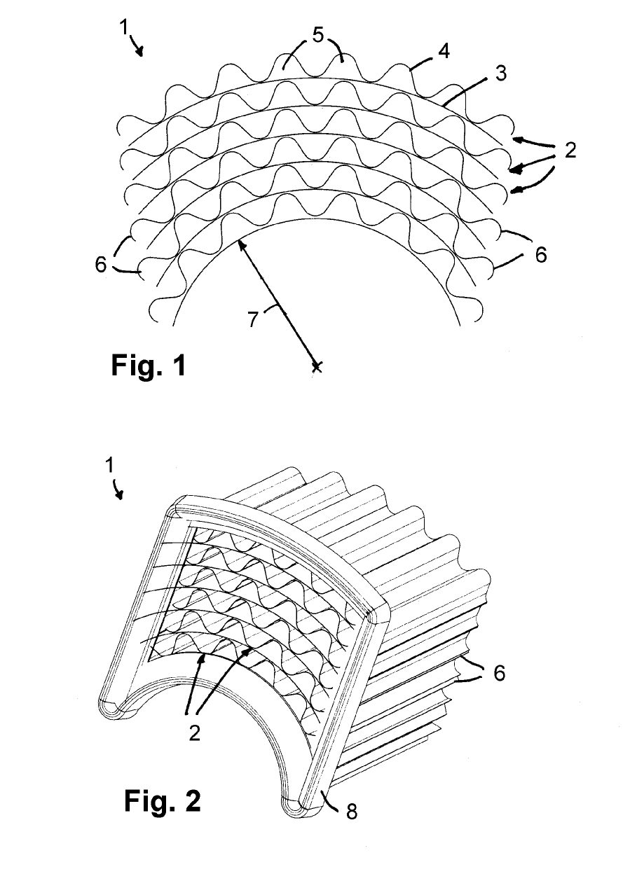

In FIG. 1, a filter element 1 is shown, which can be used for gas filtration, for example for air filtration in motor vehicles. The filter element 1 comprises a plurality of single sheets 2, each of which consist of a covering layer 3, which is designed in the initial state as a flat layer, and a corrugated layer 4 placed on the covering layer 3, so that due to the waveform of the corrugated layer 4, flow channels 5 are formed between the layers 3 and 4. All flow channels 5 extend longitudinally and lie parallel to one another. In each single sheet 2, the covering layer 3 and the corrugated layer 4 are connected to one another, in particular by means of adhesion, and additionally the stacked single sheets are likewise connected, in particular through adhesion. The connection between the stacked single sheets is carried out in such a manner that adhesive is applied to the upper tops of the waves of a corrugated layer 4 and then a further single sheet 2 is placed on, so that the lower covering layer 3 of the upper single sheet 2 is connected to the upper corrugated layer 4 of the lower single sheet.

The single sheets 2 are designed in a curved manner, the curvature is designated by the arrow 7, which indicates the radius of a virtual center point to the lowest, most curved single sheet. The center point of the arrow 7 represents the axis of curvature.

The single sheets 2 lie directly atop one another and are concentric; with the increasing radial distance from the virtual center point, the curvature decreases due to the larger radius.

The different single sheets 2 are identically constructed and have the same basic geometry and the same height and waveform in the corrugated layer 4. Because the single sheets lying closer to the virtual center point have a greater curvature as the single sheets lying radially farther away, the lateral end edges 6 of the single sheets 2 lie in a common plane, wherein the planes of the opposite end edges 6 form an angle to each other, which depends on the curvature of the single sheets. With a greater curvature, the angle between the planes of the lateral end edges 6 also increases. If an angle between the lateral planes of the end edges 6 deviating therefrom is desired, either the single sheets may be set with differing widths and/or the end edges undergo a post-treatment, for example trimming, whereby for example parallel planes of the opposite end edges 6 can be achieved.

The flowing of the filter element 1 occurs via the end face through the open lateral openings of the flow channels 5, which are closed on the axially opposite ends, so that the inflowing fluid must pass radially through the walls of the flow channels.

In FIG. 2, a perspective view of a filter element 1 with a plurality of superposed single sheets 2 is shown, which has an arched curvature just as in FIG. 1. In addition, the filter element is enclosed on its end face by a frame-shaped, circumferential sealing element 8, which protrudes axially as well as radially. The opposite planes with the lateral end edges 6 extend parallel to one another. The sealing element 8 gives the filter element 1 additional stability.

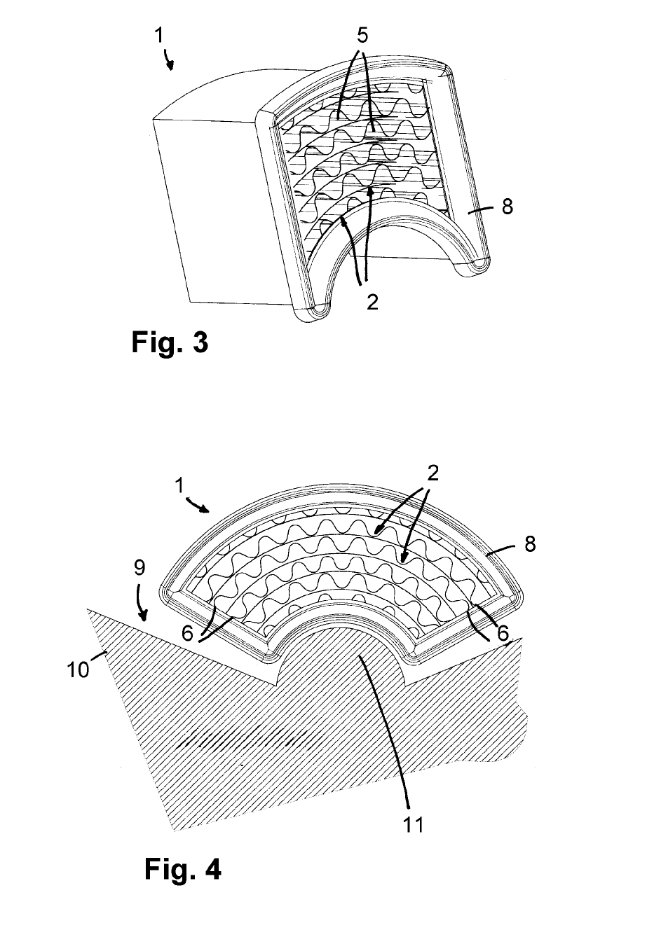

In FIG. 3, a filter element is shown which corresponds in its basic structure to that of FIG. 2. However, the lateral surfaces are formed with a smooth surface, for example, by applying an adhesive such as hot melt, whereby a flow-tight seal is achieved in the region of the outer contour of the filter element 1, so that only an axial flow through the flow channels 5 is possible. All four lateral surfaces of the filter element 1 are formed as smooth surfaces, wherein only the lateral surfaces in the region of the lateral end edges are flat, whereas the upper and lower lateral surfaces of the single sheets have a corresponding curvature.

In FIG. 4, a view of a filter element 1 in the installed position in a receiving space 9 of a filter housing 10 is shown. An elevation 11 of the filter housing protrudes into the receiving space 9, the outer contour of which elevation 11 corresponds approximately to the inner curvature of the filter element 1. Accordingly, the filter element 1 may be placed with its inner curvature on the rounded elevation 11 and the receiving space 9 is exploited in the best possible way.

The lateral end edges 6 each lie in planes which enclose with one another a relatively large angle of approximately 120°. This angle is approximately corresponds to the angle between two bottom-side base areas in the receiving space 9, which extend on both sides of the rounded elevation 11. The filter element 1 is thus also adapted to the contour of the receiving space 9 in the filter housing 10 with its end edges and the plane in which the end edges lie.

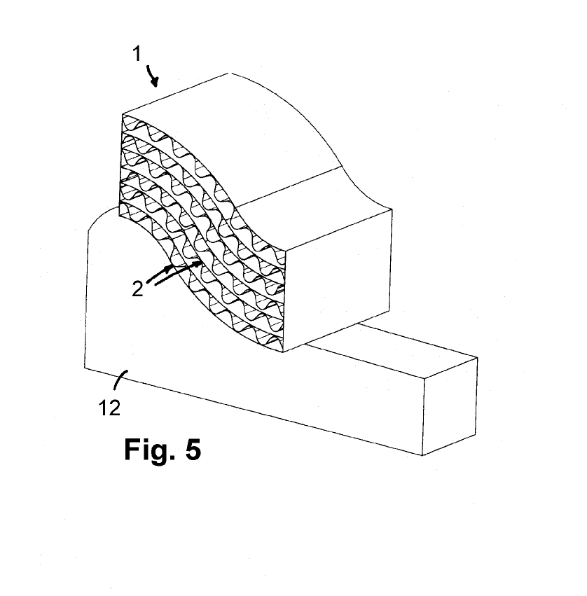

The embodiments according to FIGS. 1 to 4 each show filter elements 1 with only one curvature of the single sheets 2. In contrast, FIG. 5 shows a filter element 1 with a double, opposite S-shaped curvature. The lowermost single sheet 2 lies flat on the underlay 12, which has a corresponding double-curved surface.

For producing the filter element 1, the different single sheets 2 are placed layer by layer on top of one another and connected to one another by adhesion. First, the first, lowermost single sheet 2 is placed on the underlay 12, wherein the alignment takes place in such a manner that the curvature—just as in the embodiments according to FIGS. 1 to 4—extends parallel to the longitudinal extent of the flow channels 5.

The lowermost single sheet 2 is placed flatly on the top surface of the underlay 12, so that the lowermost single sheet 2 follows the contour of the underlay 12. Then, the further single sheets are stacked onto one another, wherein the connection between the single sheets takes place by means of adhesion in the region of the tops of the waves in the corrugated layer and the covering layer lying thereon and in addition the formation of alternatingly closed channels occurs. In the curved sections, the different individual sheets lie concentric with one another and have a curvature adapted to one another, which decreases with the increasing radius to the center of the curvature. Due to the adhering of the curved single sheets, one obtains an inherently stable filter element, which retains its curved shape even without the action of external forces.

After all of the single sheets in the filter element 1 are connected with one another, a frame or sealing element can optionally be arranged on the filter element.

What is claimed is:

1. A filter element, comprising:
a plurality of superposed single sheets, each sheet including
a corrugated layer; and
a covering layer for forming parallel flow channels;
wherein the plurality of superposed single sheets are connected to one another;
wherein the plurality of single sheets are not flat and have at least one curvature and are connected in the curved state, so that the curved filter element formed from the single sheets is inherently stable and have an axis of curvature that extends parallel to the flow channels.

2. The filter element according to claim 1, wherein
the plurality of superposed single sheets are connected to one another by an adhesive.

3. The filter element according to claim 2, wherein
the plurality of superposed single sheets are connected to one another by an adhesive arranged at in a region of peaks of waves of the flow channels.

4. The filter element according to claim 1, wherein
the individual of the plurality of single sheets are identically constructed.

5. The filter element according to one of claim 1, wherein
the plurality of single sheets have exactly one curvature and the filter element is formed as an arch.

6. The filter element according to claim 1, wherein
the plurality of individual single sheets each have at least two curvatures.

7. The filter element according to claim 1, wherein
a circumferential sealing element is arranged on the filter element.

8. The filter element according to claim 1, wherein
lateral end edges on at least one side of the of the plurality of superposed single sheets lie in a common plane.

9. The filter element according to claim 8, wherein
the lateral end edges on both of two opposite sides of the filter element extend parallel.

10. The filter element according to claim 8, wherein
the lateral end edges on a side side of the filter element line in a first plane;
the lateral end edges on a second side side of the filter element line in a second plane;
wherein the first plane and second plane intersect at an angle of: 0<angle<90 degrees.

11. The filter element according to claim 3, wherein
at least one of the plurality of superposed single sheets is a covering layer arranged directly on and covering the peaks of waves of the flow channels and an adjacent one of the plurality of superposed single sheets;
the covering layer is formed as a planar or flat-surfaced layer.

12. A filter apparatus comprising:
a filter element, including:
a plurality of superposed single sheets, each sheet including
a corrugated layer; and
a covering layer for forming parallel flow channels;
wherein the plurality of superposed single sheets are connected to one another;
wherein the plurality of single sheets are not flat and have at least one curvature and are connected in the curved state, so that the curved filter element formed from the single sheets is inherently stable and have an axis of curvature that extends parallel to the flow channels; and
a filter housing having an interior into which the filter element is received.

13. The filter apparatus according to claim 12 as an air filter for a motor vehicle.

14. A method for manufacturing a filter element,
wherein the filter element includes:
a plurality of superposed single sheets, each sheet including
a corrugated layer; and
a covering layer for forming parallel flow channels;
wherein the plurality of superposed single sheets are connected to one another;
wherein the plurality of single sheets are not flat and have at least one curvature and are connected in the curved state, so that the curved filter element formed from the single sheets is inherently stable and have an axis of curvature that extends parallel to the flow channels;
the method comprising the steps of:
providing a non-planar underlay upon which to construct the filter element;
placing at least one first sheet of the plurality of superposed single sheets onto the non-planar underlay in such a way that the at least one first sheet is curved about an axis of curvature parallel to the flow channels;
applying at least one second sheet of the plurality of superposed single sheets having a corresponding curvature corresponding to curvature of the at least one first sheet onto the at least one first sheet; and
connecting the at least one first sheet with the at least one second sheet.
